(19) United States
(12) Patent Application Publication
(10) Pub. No.: US 2003/0067932 A1
(43) Pub. Date: Apr. 10, 2003

(54) Priority service process for serving data units on a network

(76) Inventor: Geping Chen, Northborough, MA (US)

Correspondence Address: DENIS G. MALONEY, Fish & Richardson P.C., 225 Franklin Street, Boston, MA, 02110-2804, US

(21) Appl. No.: 10/023,281

(22) Filed: Dec. 13, 2001

Related U.S. Application Data
(60) Provisional application No. 60/295,601, filed on Jun. 4, 2001.

(51) Int. Cl. H04L 12/54

(52) U.S. Cl. 370/412; 370/428

(57) ABSTRACT

Serving data units on a network includes queuing data units from a first application in a first buffer, queuing data units from a second application in a second buffer, moving data units from the second buffer to the first buffer following a predetermined delay, and serving data units from the first buffer.

### CROSS-REFERENCE TO RELATED APPLICATION

This application claims priority to U.S. Provisional Patent Application No. 60/295,601, filed Jun. 4, 2001, entitled “Non-Copying Buffer Handling For Porting A Protocol Stack To Drivers”, the contents of which are hereby incorporated by reference into this application as if set forth herein in full.

### TECHNICAL FIELD

This invention relates to serving data units on a network.

### BACKGROUND

Asynchronous transfer mode (ATM) has been selected as the Committee on Civilian Industrial Technology (CCITT) standard for switching and multiplexing on Broadband-Integrated Service Digital Networks (B-ISDN). B-ISDN supports services with diversified traffic characteristics and Quality of Service (QoS) requirements, such as data transfer, telephone/videophone, high definition television (HDTV), multimedia conferencing, medical diagnosis and real-time control.

To efficiently utilize network resources through multiplexing, while providing the required QoS to supported multiple applications, the service to a specific application should be dependent on the QoS requirements of that application. QoS is typically described in terms of some measure of the delay or loss that data units of an application suffer over a transmission path from source to destination. Since the universal data unit of an ATM network is the (fixed size) cell, QoS requirements for ATM are usually described in terms of some metric of the cell delay and cell loss.

One objective of a priority service scheme is to deliver service that is as close as possible to the target QoS specified by the associated cell delay/loss metric. A priority service scheme can be defined in terms of a cell serving (i.e., transmitting) policy specifying: (a) which of the arriving cells are admitted to network buffer(s) and/or (b) which of the admitted cells is served next from those buffer(s). The former type of priority service scheme is typically referred to as a “space-priority” scheme and impacts on the delivered cell loss metric. The latter type is typically referred to as a “time-priority” (or priority-scheduling) scheme and impacts on the delivered cell delay metric.

In the absence of priority service, the network load may be set at a potentially very low level in order to provide the most stringent QoS to all applications on the network. Considering that QoS requirements can differ substantially for different applications, a non-priority service scheme may result in severe underutilization of the network's resources. For instance, cell loss probability requirements can range from 10² to 10¹⁰ cells and end-to-end cell delay requirements for real-time applications can range from below 25 milliseconds (ms) to 1000 ms.

### SUMMARY

In general, in one aspect, the invention is directed to a priority service scheme for serving data units on a network. This aspect includes queuing data units from a first application in a first buffer, queuing data units from a second application in a second buffer, moving data units from the second buffer to the first buffer following a predetermined delay, and serving data units from the first buffer. This aspect of the invention may include one or more of the following features.

The data units from the first application may have a higher priority for transmission on the network than the data units from the second application. The data units from the first application and the data units from the second application may be served from the first buffer on a first-come-first-served basis. Data units from the first application that exceed a first time delay may be discarded and data units from the second application that exceed a second time delay may be discarded. The second time delay may exceed the predetermined time delay.

The data units from the second buffer may be moved to an end of the first buffer after data units from the first application. A time to move the data units from the second buffer to the first buffer may be determined. A circular buffer, a pointer and a timer may be used to determine the time to move the data units from the second buffer to the first buffer. Data units may be served from the second buffer when the first buffer is empty. The data units may include Asynchronous Transfer Mode (ATM) cells and the network may be an ATM network.

This summary has been provided so that the nature of the invention can be understood quickly. A detailed description of illustrative embodiments of the invention is set forth below.

### DESCRIPTION OF THE DRAWINGS

FIG. 1 is a block diagram of buffers for serving data units.

FIG. 2 is a block diagram of part of a controller for determining a timing at which the data units may be moved between the buffers of FIG. 1.

FIG. 3 is a graph showing axes used in a performance analysis of a method for serving the data units from the buffers.

FIG. 4 is a graph showing a renewal cycle for cells on the axes of FIG. 3.

FIG. 5 is a view of a computer on which the method for serving the data units from the buffers may be implemented.

### DETAILED DESCRIPTION

One factor in ATM network design is providing diversified QoS to applications with distinct characteristics. This is of particular importance in real-time applications, such as streaming audio and video. Buffer management schemes can play a role in providing the necessary diversification through an ATM cell admission and service policy. A flexible priority service policy for two applications (classes) with strict—and in general distinct—deadlines and different deadline violation rates is described herein. The flexible service policy described herein utilizes a buffer management scheme to provide the requisite QoS to the different applications.

Consider two different classes of traffic (from, e.g., two different computing applications) sharing a transmission link between a transmitter (not shown) and a receiver (not shown). The link is slotted and capable of serving one data unit (in the case of ATM, a cell) per time slot. Let H (for high priority) and L (for low priority) denote the two classes of traffic and let superscript X^{Y} denote a quantity associated with traffic class X^{Y}. A process 10 for serving ATM cells from a device, such as a router or general-purpose computer, to an ATM network, is as follows:

(1) H-cells (i.e., cells of an application “H”) join the “Head of the Line” (HoL) service class upon arrival. HoL cells are served according to the HoL priority policy; i.e., no service is provided to other cells unless no HoL cell is present. H-cells that experience a delay of more than T^{H} slots are discarded.

(2) L-cells (i.e., cells of an application “L”) are served according to D-HoL priority. That is, L-cells join the HoL service class (as fresh arrivals) only after they have waited for D (D≧1) time slots. Since the service policy is assumed to be work-conserving, L-cells may be served before they join the HoL class provided that no HoL class cells are present. L-cells that experience a delay of more than T^{L} slots are discarded. It is assumed that T^{L}≧D.

(3) Within each service class (HoL or waiting-to-join L-cells), cells are served according to the First-Come First Served (FCFS) policy. In the FCFS policy, the first cell to arrive at the buffer is the first cell to be output from the buffer.

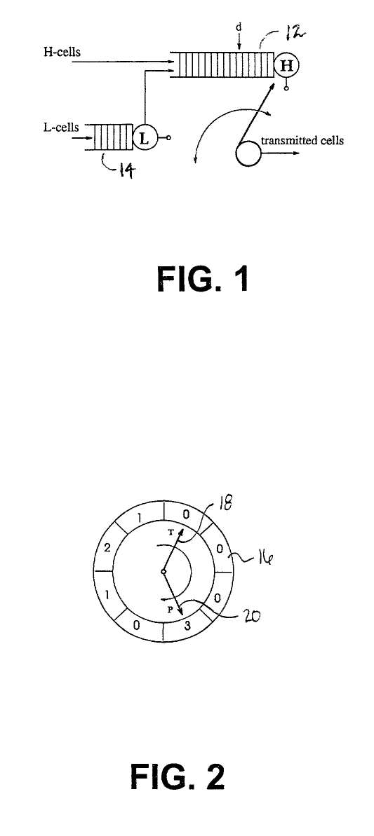

The cell serving policy of process 10 may be implemented by considering time-stamps associated with each cell arrival. However, such an approach may not be realistic for a high-speed, low-management complexity switching system. A simpler implementation of the cell serving policy of process 10 is shown in FIG. 1.

Referring to FIG. 1, as H-cells arrive, the H-cells are immediately queued (i.e., stored) in H-buffer 12. If the occupancy of H-buffer 12 exceeds a predetermined threshold (in this embodiment, a threshold that corresponds to T^{H}), newly-arriving H-cells are discarded (e.g., cells for real-time video that arrive past their preset “playout” time may be discarded). Since H-buffer 12 is served under the HoL priority policy, the discarded H-cells are precisely the ones whose deadline T^{H} would be violated. Accordingly, losing those cells will have little impact on overall QoS. L-cells are queued in L-buffer 14 as they arrive. In this embodiment, L-buffer 14 is served only when H-buffer 12 is empty. Otherwise, cells in L-buffer 14 that experience a delay D are moved to the end of the queue of H-buffer 12, provided that the occupancy of H-buffer 12 does not exceed T^{L}−D, in which case these L-cells are discarded. The L-cells are served from the H-buffer in turn. Again, since H-buffer 12 is served under the HoL priority policy, the discarded L-cells are the ones whose deadline T^{L} would be violated. Accordingly, losing those cells will have little impact on overall QoS.

The arrangement shown in FIG. 1 implements (deadline-violating) cell discarding through a simple buffer threshold policy, avoiding a more complex time-stamping approach. The capacity of H-buffer 12 and L-buffer 14 are equal to max(T^{H}, T^{L}−D) and min (T^{L}, DNₘₐₓ), respectively; where Nₘₐₓ is the maximum number of L-cell arrivals per slot. The threshold “d” in FIG. 1 is equal to min (T^{H}, T^{L}−D). If min(T^{H}, T^{L}−D)=T^{H}, then any H-cells more than d cells in H-buffer 12 are discarded.

There are several ways of identifying the time to move L-cells from L-buffer 14 to H-buffer 12. For example, time-stamping may be used (i.e., examining cell time-stamps). Time-stamp-based sorting in every slot presents a level of complexity that may not be tolerable in a high-speed networking environment. For this reason, alternatives to time-stamp-based implementation approaches may be used. For example, a list of cell arrival times and a clock may be used to control cell movement.

In this embodiment, a circular buffer (registers) that records the number of cell arrivals per slot is used. Referring to FIGS. 1 and 2, the L-buffer controller may be a microprocessor, microcontroller, or the like that includes (or uses) a pool of D registers 16, a timer T 18, and a pointer P 20. The timer counts from 0 to D−1, increasing its content by one (1) at the count of every slot. After D−1, the timer is reset at the next slot and then continues counting. The current content of the timer indicates the register where the number of L-cell arrivals during the current slot are registered.

The pool of registers 16 may be viewed as a circular structure and the timer T may be viewed as a rotating pointer pointing to a register to be used at a current time (FIG. 2) (although this is not necessarily its actual structure). The register visited by timer T contains the number of L-cells that have experienced a delay D in L-buffer 14. These cells, which are at the head of L-buffer 14, are moved to H-buffer 12 and the number of new L-cell arrivals over the current slot are registered in this register.

The timer T identifies the time that L-cells are moved to H-buffer 12. A mechanism may also be used to determine changes in the content of the registers due to service provided to L-cells that are in L-buffer 14. The pointer P is used for this purpose. This pointer P points to the (non-zero-content) register containing the number of L-cells that are the oldest in L-buffer 14. When service is provided to L-buffer 14—i.e., when the H-buffer 12 is empty—the content of the register pointed to by pointer P is decreased by one. The pointer P moves from a current register to a next non-zero-content register if the content of the current register becomes zero. This occurs if the content of the current register is one and service is provided to an L-cell or if the timer T visits this register, and thus the corresponding L-cells are moved to H-buffer 12. If there is currently no L-cell in L-buffer 14, pointer P equals timer T.

The following evaluates the diversified QoS provided to the two classes of traffic, L and H, by the cell serving policy of process 10. Here, QoS is defined in terms of the induced cell loss probability, noting that cell loss and cell deadline violation are identical events under process 10. The diversity in the QoS requirements for the two applications served under process 10 is represented by differences in cell delay deadlines and cell loss probabilities. By controlling the delay D before the L-cells qualify for service under the HoL priority, it is expected that the induced cell loss probability will be affected substantially. The effectiveness of the D parameter is demonstrated through numerical results. The approach can be modified to yield other QoS measures such as the average cell delay and the tail of the cell delay distribution.

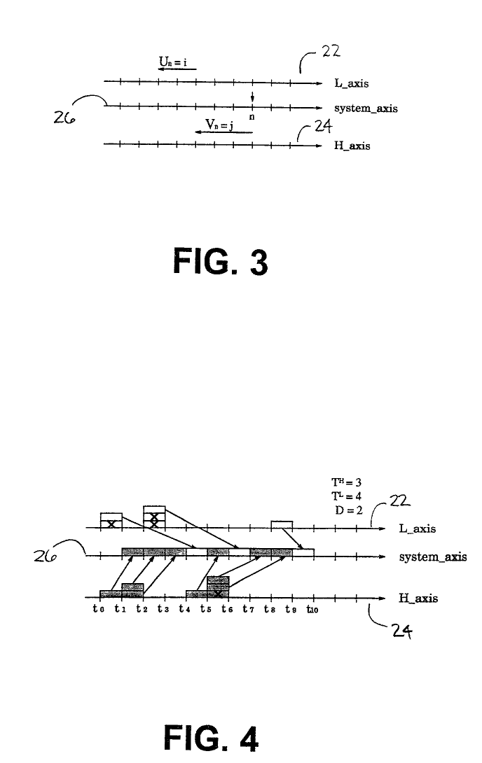

FIG. 3 shows three axes, which are used in the performance analysis of process 10. The L-axis 22 is used to describe L-cell arrivals at the time they occur. The H-axis 24 is used to describe H-cell arrivals at the time they occur. The system axis 26 is used to mark the current time. In this example, cell arrival and service completions are assumed to occur at the slot boundaries.

The H-cell and L-cell arrival processes are assumed to be independent and governed by geometrically distributed (per slot) batches with parameters q^{H} and q^{L}, respectively. The probability that the batch sizes N^{H} and N^{L} are equal to n is given by

P^{H}(N^{H}=n)=(q^{H})ⁿ(1−q^{H}), P^{L}(N^{L}=n)=(q^{L})ⁿ(1−q^{L}), n=0, 1, 2, . . . (1)

and the mean H-cell (L-cell) arrival rate is given by

$${λ}^{H} = \frac{{q}^{H}}{1 - {q}^{H}} ( {λ}^{L} = \frac{{q}^{L}}{1 - {q}^{L}} ) \qquad ( 2 )$$

It is noted that the assumptions concerning the arrival processes considered above are not critical, since they can be changed in any number of ways. For instance, two-state Markov arrival processes may be considered and the resulting system may be analyzed by applying the same approach (but requiring increased computations). The subject cell serving policy is also applicable to arrival processes that are independent and identically distributed with arbitrarily distributed batch sizes. In this case, the maximum batch size affects the magnitude of the numerical complexity.

The following analysis is based on renewal theory. Let n, n∈N, denote the current time, where N denotes the set of natural numbers. At this time, n, the server is ready to begin the service of the next cell. Consider the following definitions

| | |
|---|---|
| Vn: | A random variable describing the current length (in slots) of the |
| | unexamined interval at the H-axis. That is, all H-cell arrivals |
| | before time n − Vₙ have been served, since no H-cell arrival after |
| | time n − Vₙ + 1 has been considered for service by time n. |
| Un: | A random variable such that Un + Vn describes the current length |
| | of the unexamined intervals on the L-axis. |

It is shown that {Uₙ, Vₙ}_{n∈N} is a Markov process. Let {sₖ}_{k∈N} denote a sequence of time instants (slot boundaries) at which the system is empty; {sₖ}_{k∈N} is a renewal sequence. Consider the following definitions.

| | |
|---|---|
| Yₖ: | A random variable describing the length of the kth renewal |
| | cycle; Y will denote the generic random variable (associated |
| | with a renewal cycle). |
| Yₖ^{H}/Yₖ^{L}: | A random variable describing the number of H-cells/L-cells |
| | transmitted over the kth renewal cycle; Y^{H}/Y^{L} will |
| | denote the generic random variable. |
| Lₖ^{H}/Lₖ^{L}: | A random variable describing the number of H-cells/L-cells |
| | lost over the kth renewal cycle; L^{H}/L^{L} will denote the generic |
| | random variable. |

It can be shown that

Yₖ=Yₖ^{H}+Yₖ^{L}+1, for Yₖ≧1 (3)

Referring to FIG. 4, a renewal cycle is shown. Cells marked by “x” are the ones that are lost (due to violation of the associated deadline). Transmitted cells are shown on the system axis. In this example, T^{H}=3, T^{L}=4, and D=2. The renewal cycle begins at time t₀, at which time no cell is present. The first slot of the renewal cycle is always idle (no transmission occurs). At time slot t₄, one L-cell is served and the first L-cell is discarded due to the expiration of its deadline (t₄−t₁=T^{L}). In fact, at t³, the first two L-cells switch to H-buffer 12, but only one is served before its deadline. At t₅, the L-cells that arrived at t₃ switch to H-buffer (t₅−t₃=D). The H-cell that arrived at t₅ is served before these L-cells. At t₉, the L-cell is served since no H-cell is present. At t₁₀, no cell is present and the renewal cycle ends. In this example, Yₖ=10, Yₖ^{H}=6, Yₖ^{L}=3, Lₖ^{H}=1, and Lₖ^{L}=3.

The evolution of the process {Uₙ, Vₙ} can be derived for the example shown in FIG. 4. Notice that when Uₙ>D, Uₙ points to the oldest unexamined slot that is to be served under the HoL priority. The associated L-cells have switched priority and are the oldest cells in the system. If Uₙ<D, Vₙ points to the oldest unexamined slot that is to be served under the HoL priority. If Uₙ=D, the oldest unexamined intervals in both axes have the same priority and the selection is made according to a probabilistic. One possible evolution of {Uₙ, Vₙ} corresponding to FIG. 4 is shown below:

t₁: (0, 1)

t₂: (0, 2)→(1, 1)

t₃: (1, 2)

t₄: (1, 3)→(2, 2)

t₅: (1, 3)→(2, 2)→(1, 2)→(2, 1)

t₆: (2, 2)

t₇: (1, 3)→(2, 2)→(1, 2)

t₈: (1, 3)

t₉: (1, 3)→(2, 2)→(1, 2)→(2, 1)→(1, 1)→(2, 0)→(1, 0)

t₁₀: (1, 1)→(2, 0)→(1, 0)→(0, 0)

4.2. Derivation of System Equations

The following definitions will be used in the analysis:

| | |
|---|---|
| Y^{H} (i, j): | A random variable describing the number of H-cells trans- |
| | mitted over the interval between a time slot at which {Uₙ, Vₙ} |
| | is in state (i, j) and the end of the renewal cycle which con- |
| | tains this slot. |
| Y^{L} (i, j): | A random variable defined as Y^{H} (i, j) for L-cells. |
| I^{H} (I^{L}): | An indicator function assuming the value 1 if an H-cell (L- |
| | cell) is present at the slot of H-axis (L-axis) under current |
| | examination (as pointed to by Vₙ or Uₙ + Vₙ); it assumes |
| | the value 0 otherwise. |
| Î^{H} (Î^{L}): | An indicator function defined as Î^{H} = 1 − I^{H} (Î^{L} = 1 − I^{L}). |
| [i, j]*: | It is a function which determines the next state of {Uₙ, Vₙ} |
| | taking into consideration possible violation of T^{L}: |

$${[ i , j ]}^{*} = \{ \begin{matrix}( i , j ) , & i + j \leq {T}^{L} , \\ ( {T}^{L} - j , j ) & otherwise .\end{matrix}$$

| | |
|---|---|
| m: | It denotes the lowest possible value of random variable |
| | Vₙ; m = 0 if D ≠ 0 and m = −1 if D = 0. |
| I_{{H}} (I_{{L}}): | An indicator function associated with decisions regarding |
| | the slot to be examined next when Uₙ = D.I_{{H}} = 1 |
| | (I_{{L}} = 1) if the oldest unexamined slot in H-axis (L-axis) is |
| | considered next, and I_{{H}} = 0(I_{{L}} = 0) otherwise. This |
| | is a design parameter which can impact on the induced cell |
| | losses. In Appendix A, the expected values of these func- |
| | tions (μ^{H} = P {I_{{H}} = 1}, μ^{L} = P {I_{{L}} = |
| | 1}) are derived under the assumption that all cells (from |
| | both classes) arrived over the slots to be examined when |
| | Uₙ = D are equally likely to be selected. \overline{X}: Denotes |
| | E {X}, where E {·} is the expectation operator. |

In the sequel, recursive equations are derived for the calculation of \overline{Y}^{H} and \overline{Y}^{L}. Then, similar equations are derived for the calculation of \overline{L}^{H} and \overline{L}^{L}. As it will be shown later, these quantities will yield the cell loss probabilities. Finally, the similar approach for the calculation of the average cell delay and cell delay tail probabilities is outlined at the end of this section.

It is easy to observe that no cell is transmitted in the first slot and thus, process {Uₙ, Vₙ} actually starts from state (0, 1). Thus,

Y^{H}=Y^{H}(0, 1), Y^{L}=Y^{L}(0, 1) (4)

A careful consideration of the evolution of the recursions presented below shows that when process {Uₙ, Vₙ} reaches the state (0, 0), the renewal cycle ends. For this reason,

Y^{H}(0, 0)=0, Y^{L}(0, 0)=0 (5)

to terminate the current cycle. Notice also that Uₙ can exceed D+1 only if Vₙ=T^{H}.

Case A. T^{L}≧T^{H}

$$\begin{matrix}Case A .1 . {T}^{H} > j > 0 , min ( {T}^{L} - j , D + 1 ) \geq i \geq m . & \\ 1. i < D \text{:} \\ \begin{matrix}{Y}^{H} ( i , j ) = {I}^{H} + {Y}^{H} ( {[ i + {\hat{I}}^{H} , j - 2 {\hat{I}}^{H} + 1 ]}^{*} ) , \\ {Y}^{L} ( i , j ) = {Y}^{L} ( {[ i + {\hat{I}}^{H} , j - 2 {\hat{I}}^{H} + 1 ]}^{*} ) .\end{matrix} & ( 6 ) \\ 2. i = D + 1 \text{:} \\ \begin{matrix}{Y}^{H} ( D + 1 , j ) = {Y}^{H} ( {[ i - {\hat{I}}^{L} , j - {\hat{I}}^{L} + 1 ]}^{*} ) , \\ {Y}^{L} ( D + 1 , j ) = {I}^{L} + {Y}^{L} ( {[ i - {\hat{I}}^{L} , j - {\hat{I}}^{L} + 1 ]}^{*} ) .\end{matrix} & ( 7 ) \\ 3. i = D \text{:} \\ \begin{matrix}{Y}^{H} ( D , j ) = \{ {I}^{H} + {Y}^{H} ( {[ i + {\hat{I}}^{H} , j - 2 {\hat{I}}^{H} + 1 ]}^{*} ) \} {I}_{\{ H \}} + \\ {Y}^{H} ( {[ i - {\hat{I}}^{L} , j - {\hat{I}}^{L} + 1 ]}^{*} ) {I}_{\{ L \}} . \\ {Y}^{H} ( D , j ) = {Y}^{L} ( {[ i + {\hat{I}}^{H} , j - 2 {\hat{I}}^{H} + 1 ]}^{*} ) {I}_{\{ H \}} + \\ \{ {I}^{L} + {Y}^{L} ( {[ i - {\hat{I}}^{L} , j - {\hat{I}}^{L} + 1 ]}^{*} ) \} {I}_{\{ L \}} .\end{matrix} \\ Case A .2 . j = {T}^{H} , {T}^{L} - {T}^{H} \geq i \geq m . & ( 8 ) \\ 1. i < D \text{:} \\ \begin{matrix}{Y}^{H} ( i , {T}^{H} ) = {I}^{H} + {Y}^{H} ( {[ i + 1 , {T}^{H} - {\hat{I}}^{H} ]}^{*} ) , \\ {Y}^{L} ( i , {T}^{H} ) = {Y}^{L} ( {[ i + 1 , {T}^{H} - {\hat{I}}^{H} ]}^{*} ) .\end{matrix} & ( 9 ) \\ 2. i \geq D + 1 \text{:} \\ \begin{matrix}{Y}^{H} ( i , {T}^{H} ) = {Y}^{H} ( {[ i - 2 {\hat{I}}^{L} + 1 , {T}^{H} ]}^{*} ) , \\ {Y}^{L} ( i , {T}^{H} ) = {I}^{L} + {Y}^{L} ( {[ i - 2 {\hat{I}}^{L} + 1 , {T}^{H} ]}^{*} ) .\end{matrix} & ( 10 ) \\ 3. i = D \text{:} \\ \begin{matrix}{Y}^{H} ( D , {T}^{H} ) = \{ {I}^{H} + {Y}^{H} ( {[ i + 1 , {T}^{H} - {\hat{I}}^{H} ]}^{*} ) \} {I}_{\{ H \}} + \\ {Y}^{H} ( {[ i - 2 {\hat{I}}^{L} + 1 , {T}^{H} ]}^{*} ) {I}_{\{ L \}} , \\ {Y}^{L} ( D , {T}^{H} ) = {Y}^{L} ( {[ i + 1 , {T}^{H} - {\hat{I}}_{H} ]}^{*} ) {I}_{\{ H \}} + \\ \{ {I}^{L} + {Y}^{L} ( {[ i - 2 {\hat{I}}^{L} + 1 , {T}^{H} ]}^{*} ) \} {I}_{\{ L \}} .\end{matrix} \\ Case A .3 . j = 0 , min ( {T}^{L} , D + 1 ) \geq i \geq 1. & ( 11 ) \\ {Y}^{H} ( i , 0 ) = {Y}^{H} ( {[ i - {\hat{I}}^{L} , 1 - {\hat{I}}^{L} ]}^{*} ) , \\ {Y}^{H} ( i , 0 ) = {I}^{L} + {Y}^{L} ( {[ i - {\hat{I}}^{L} , 1 - {\hat{I}}^{L} ]}^{*} ) , & ( 12 )\end{matrix}$$

Case B. T^{L}<T^{H}

The equations under this case are derived similarly and are presented in Appendix B. By applying the expectation operator to the above equations, the following systems of linear equations are obtained, details are presented in Appendix C:

$${\overline{Y}}^{H} ( i , j ) = {a}^{H} ( i , j ) + {\sum }_{( {i}^{′} , {j}^{′} ) ∈ {R}_{0}} {b}^{H} ( i , j , {i}^{′} , {j}^{′} ) {\overline{Y}}^{H} ( {i}^{′} , {j}^{′} ) , \\ {\overline{Y}}^{L} ( i , j ) = {a}^{L} ( i , j ) + {\sum }_{( {i}^{′} , {j}^{′} ) ∈ {R}_{0}} {b}^{L} ( i , j , {i}^{′} , {j}^{′} ) {\overline{Y}}^{H} ( {i}^{′} , {j}^{′} ) , \qquad ( 13 )$$

where R₀={(i, j): m≦i≦T^{L}, 0≦j≦T^{H}}. It should be noted that these systems of linear equations are extremely sparse: only two to four coefficients are not zero per equation. Thus, it can be solved efficiently by using an iterative approach. The computation complexity is of the order of DT^{H}. For T^{H} and D<100, it takes less than a couple of hours to solve these equations in a SUN SPARC20 workstation. From the solution of these equations, \overline{Y}^{H} and \overline{Y}^{L} are obtained from (see (4))

\overline{Y}^{H}=\overline{Y}^{H}(0, 1), \overline{Y}^{L}=\overline{Y}^{L}(0, 1) (14)

The expected value of the number of H-cells (L-cells) lost over a renewal cycle, \overline{L}^{H}(\overline{L}^{L}), is derived by following a similar approach. The following quantities need to be defined first.

| | |
|---|---|
| L^{H} (i, j) (L^{L} (i, j)): | A random variable describing the number of H-cells |
| | (L-cells) discarded over the interval between a time |
| | slot at which {Uₙ, Vₙ} is in state (i, j) and the end of |
| | the renewal cycle which contains this slot. |
| S_{{i, j}}: | An indicator function assuming the value 1 if there is a |
| | possibility to discard an L-cell as a result of the service |
| | to be provided in the current slot (due to resulting |
| | violation of its deadline T^{L}): |

$${S}_{\{ i , j \}} = \{ \begin{matrix}1 & if i + j = {T}^{L} , \\ 0 & otherwise .\end{matrix}$$

The equation for the derivation of Lₙ^{H} and Lₙ^{L} are similar to those for the derivation of Yₙ^{H} and Yₙ^{L} and are given below. Notice again that

L^{H}=L^{H}(0, 1), L^{L}=L^{L}(0, 1) (15)

and

L^{H}(0, 0)=0, L^{L}(0, 0)=0 (16)

Two cases need to be considered: T^{L}≧T^{H} and T^{L}<T^{H}.

Case A. T^{L}≧T^{H}

$$\begin{matrix}Case A .1 . {T}^{H} > j > 0 , min ( {T}^{L} - j , D + 1 ) \geq i \geq m . & \\ 1. i < D \text{:} \\ \begin{matrix}{L}^{H} ( i , j ) = {L}^{H} + {Y}^{H} ( {[ i + {\hat{I}}^{H} , j - 2 {\hat{I}}^{H} + 1 ]}^{*} ) , \\ {L}^{L} ( i , j ) = {I}^{H} {S}_{\{ i , j \}} {N}^{L} + {L}^{L} ( {[ i + {\hat{I}}^{H} , j - 2 {\hat{I}}^{H} + 1 ]}^{*} ) .\end{matrix} & ( 17 ) \\ 2. i = D + 1 \text{:} \\ \begin{matrix}{L}^{H} ( D + 1 , j ) = {L}^{H} ( {[ i - {\hat{I}}^{L} , j - {\hat{I}}^{L} + 1 ]}^{*} ) , \\ {L}^{L} ( D + 1 , j ) = {I}^{L} {S}_{\{ D , j \}} {N}^{L} + {L}^{L} ( {[ i - {\hat{I}}^{L} , j - {\hat{I}}^{L} + 1 ]}^{*} ) .\end{matrix} & ( 18 ) \\ 3. i = D \text{:} \\ \begin{matrix}{L}^{H} ( D , j ) = {L}^{H} ( {[ i + {\hat{I}}^{H} , j - 2 {\hat{I}}^{H} + 1 ]}^{*} ) {I}_{\{ H \}} + \\ {L}^{H} ( {[ i - {\hat{I}}^{L} , j - {\hat{I}}^{L} + 1 ]}^{*} ) {I}_{\{ L \}} , \\ {L}^{L} ( D , j ) = \{ {I}^{H} {S}_{\{ D , j \}} {N}^{L} + {L}^{L} ( {[ i + {\hat{I}}^{H} , j - 2 {\hat{I}}^{H} + 1 ]}^{*} ) \} {I}_{\{ H \}} + \\ \{ {I}^{L} {S}_{\{ D , j \}} {N}^{L} + {L}^{L} ( {[ i - {\hat{I}}^{L} , j - {\hat{I}}^{L} + 1 ]}^{*} ) \} {I}_{\{ L \}} .\end{matrix} \\ Case A .2 . j = {T}^{H} , {T}^{L} - {T}^{H} \geq i \geq m . & ( 19 ) \\ 1. i < D \text{:} \\ \begin{matrix}{L}^{H} ( i , {T}^{H} ) = {I}^{H} {N}^{H} + {L}^{H} ( {[ i + 1 , {T}^{H} - {\hat{I}}^{H} ]}^{*} ) , \\ {L}^{L} ( i , {T}^{H} ) = {I}^{H} {S}_{\{ i , {T}^{H} \}} {N}^{L} + {L}^{L} ( {[ i + 1 , {T}^{H} - {\hat{I}}^{H} ]}^{*} ) .\end{matrix} & ( 20 ) \\ 2. i \geq D + 1 \text{:} \\ \begin{matrix}{L}^{H} ( i , {T}^{H} ) = {I}^{L} {N}^{H} + {L}^{H} ( {[ i - 2 {\hat{I}}^{L} + 1 , {T}^{H} ]}^{*} ) , \\ {L}^{L} ( i , {T}^{H} ) = {I}^{L} {S}_{\{ i , {T}^{H} \}} {N}^{L} + {Y}^{L} ( {[ i - 2 {\hat{I}}^{L} + 1 , {T}^{H} ]}^{*} ) .\end{matrix} & ( 21 ) \\ 3. i = D \text{:} \\ \begin{matrix}{L}^{H} ( D , {T}^{H} ) = \{ {I}^{H} {N}^{H} + {L}^{H} ( {[ i + 1 , {T}^{H} - {\hat{I}}^{H} ]}^{*} ) \} {I}_{\{ H \}} + \\ \{ {I}^{L} {N}^{H} + {L}^{H} ( {[ i - 2 {\hat{I}}^{L} + 1 , {T}^{H} ]}^{*} ) \} {I}_{\{ L \}} , \\ {L}^{L} ( D , {T}^{H} ) = \{ {I}^{H} {S}_{\{ D , {T}^{H} \}} {N}^{L} + {L}^{L} ( {[ i + 1 , {T}^{H} - {\hat{I}}_{H} ]}^{*} ) \} {I}_{\{ H \}} + \\ \{ {I}^{L} {S}_{\{ D , {T}^{H} \}} {N}^{L} + {L}^{L} ( {[ i - 2 {\hat{I}}^{L} + 1 , {T}^{H} ]}^{*} ) \} {I}_{\{ L \}} .\end{matrix} \\ Case A .3 . j = 0 , min ( {T}^{L} , D + 1 ) \geq i \geq 1. & ( 22 ) \\ {L}^{H} ( i , 0 ) = {L}^{H} ( {[ i - {\hat{I}}^{L} , 1 - {\hat{I}}^{L} ]}^{*} ) , \\ {L}^{L} ( i , 0 ) = {I}^{L} {S}_{\{ i , 0 \}} {N}^{L} + {L}^{L} ( {[ i - {\hat{I}}^{L} , 1 - {\hat{I}}^{L} ]}^{*} ) , & ( 23 )\end{matrix}$$

Case B. T^{L}<T^{H}

The equations under this case are derived similarly (see also Case B in the derivation of Y^{H} and Y^{L}) and are not presented due to space consideration.

By taking expectation operation to both sides of the equations, the following systems of linear equations are obtained:

$${\overline{L}}^{H} ( i , j ) = {a}^{′H} ( i , j ) + {\sum }_{( {i}^{′} , {j}^{′} ) ∈ {R}_{0}} {b}^{H} ( i , j , {i}^{′} , {j}^{′} ) {\overline{L}}^{H} ( {i}^{′} , {j}^{′} ) , \\ {\overline{L}}^{L} ( i , j ) = {a}^{′L} ( i , j ) + {\sum }_{( {i}^{′} , {j}^{′} ) ∈ {R}_{0}} {b}^{L} ( i , j , {i}^{′} , {j}^{′} ) {\overline{L}}^{H} ( {i}^{′} , {j}^{′} ) , \qquad ( 24 )$$

where R₀ and coefficients b^{H}(i, j, i′, j′) and b^{L}(i, j, i′, j′) are identical to those in system (13), and constants a′^{H}(i, j) and a′^{L}(i, j) are derived as the corresponding ones in the system in (13). Finally,

\overline{L}^{H}=\overline{L}^{H}(0, 1), \overline{L}^{L}=\overline{L}^{L}(0, 1) (25)

The cell loss probabilities Pₗₒₛₛ^{H} for H-cells and Pₗₒₛₛ^{L} for L-cells are obtained from the following expressions:

$${P}_{loss}^{H} = \frac{{\overline{L}}^{H}}{{\overline{Y}}^{H} + {\overline{L}}^{H}} , {P}_{loss}^{L} = \frac{{\overline{L}}^{L}}{{\overline{Y}}^{L} + {\overline{L}}^{L}} . \qquad ( 26 )$$

Notice that \overline{Y}^{H}+\overline{L}^{H} is the average number of H-cells over a renewal cycle which is also given by λ^{H}\overline{Y}. Similarly, \overline{Y}^{L}+\overline{L}^{L} is the average number of L-cells over a renewal cycle which is also given by λ^{L}\overline{Y}.

By invoking renewal theory, the rate of service provided to H-cell and L-cell streams—denoted by λₛ^{H} and λₛ^{L} respectively—is given by

$${λ}_{s}^{H} = \frac{{\overline{Y}}^{H}}{{\overline{Y}}^{H} + {\overline{Y}}^{L} + 1} , {λ}_{s}^{L} = \frac{{\overline{Y}}^{L}}{{\overline{Y}}^{H} + {\overline{Y}}^{L} + 1} . \qquad ( 27 )$$

Alternatively, the cell loss probabilities—given by (26)—can be obtained as

$${P}_{loss}^{H} = \frac{{λ}^{H} - {λ}_{s}^{H}}{{λ}^{H}} , {P}_{loss}^{L} = \frac{{λ}^{L} - {λ}_{s}^{L}}{{λ}^{L}} . \qquad ( 28 )$$

Notice that computation of Pₗₒₛₛ^{H} and Pₗₒₛₛ^{L} from (27) and (28) does not require computation of L^{H} and L^{L}. It should be noted, however, that Eq. (28) can potentially introduce significant numerical error, especially if the cell loss rates are very low. For this reason, results have been obtained by invoking Eq. (26) in this paper.

As stated earlier, other measures of the QoS can be derived by following the above approach. The calculation of the average delay of the successfully transmitted cells and the tail of the delay probability distribution are outlined below. Equations similar to those presented for L^{H}(i, j) and L^{L}(i, j) can be derived, where the associated quantities of interest—instead of discarded H-cells in L^{H}(i, j) and L-cells in L^{L}(i, j)—are properly defined below.

| | |
|---|---|
| C^{H} (i, j) (C^{L} (i, j)): | A random variable describing the cumulative delay |
| | of successfully transmitted H-cells (L-cells) over the |
| | interval between a time slot at which {Uₙ, Vₙ} is in |
| | state (i, j) and the end of the renewal cycle which |
| | contains this slot. |
| Bₕ^{H} (i, j) (Bₗ^{L} (i, j)): | A random variable describing the number of H-cells |
| | (L-cells) which have experienced a delay less than |
| | or equal to h (l) over the interval between a time |
| | slot at which {Uₙ, Vₙ} is in state (i, j) and the end |
| | of the renewal cycle which contains this slot. |

Then,

C^{H}=C^{H}(0, 1), C^{L}=C^{L}(0, 1), Bₕ^{H}=Bₕ^{H}(0, 1), Bₗ^{L}=Bₗ^{L}(0, 1) (29)

The average delays for H-cells and L-cells are given by

$${\overline{D}}^{H} = \frac{{\overline{C}}^{H}}{{\overline{Y}}^{H}} , {\overline{D}}^{L} = \frac{{\overline{C}}^{L}}{{\overline{Y}}^{L}} . \qquad ( 30 )$$

The tail of the delay probability distribution is given by

$${P}^{H} ( {D}^{H} > h ) = 1 - \frac{{\overline{B}}_{h}^{H}}{{\overline{Y}}^{H} + {\overline{L}}^{H}} = 1 - \frac{{\overline{B}}_{h}^{H}}{{λ}^{H} \overline{Y}} , \\ {P}^{L} ( {D}^{L} > l ) = 1 - \frac{{B}_{l}^{L}}{{\overline{Y}}^{L} + {\overline{L}}^{L}} = 1 - \frac{{B}_{l}^{L}}{{λ}^{L} \overline{Y}} . \qquad ( 31 )$$

To derive the quantities in (31), similar equations to those associated with L^{H}(i, j) or L^{L}(i, j) can be derived by replacing the first of the two right-hand side terms in those equations—counting discarded cells—by functions that count the total delay of the currently transmitted cell (in determining C^{H}(i, j) or C^{L}(i, j)) or count the number of cells transmitted over the current slot which experienced a delay of less than or equal to h or l slots (in determining Bₕ^{H}(i, j) or Bₗ^{L}(i, j)). These functions—denoted by F_{{i, j}}^{H}(F_{{i, j}}^{L}) and (Gₕ^{H}(i, j) (Gₗ^{L}(i, j)), respectively—are given by the following:

$${F}_{\{ i , j \}}^{H} = \{ \begin{matrix}j & if an H \text{-} cell is served , \\ 0 & otherwise\end{matrix} \\ {F}_{\{ i , j \}}^{L} = \{ \begin{matrix}i + j & if an L \text{-} cell is served \\ 0 & otherwise\end{matrix} \\ {G}_{h}^{H} ( i , j ) = \{ \begin{matrix}1 & if an H \text{-} cell is served and j \leq h , \\ 0 & otherwise\end{matrix} \\ {G}_{l}^{L} ( i , j ) = \{ \begin{matrix}1 & if an L \text{-} cell is served with i + j \leq l , \\ 0 & otherwise\end{matrix}$$

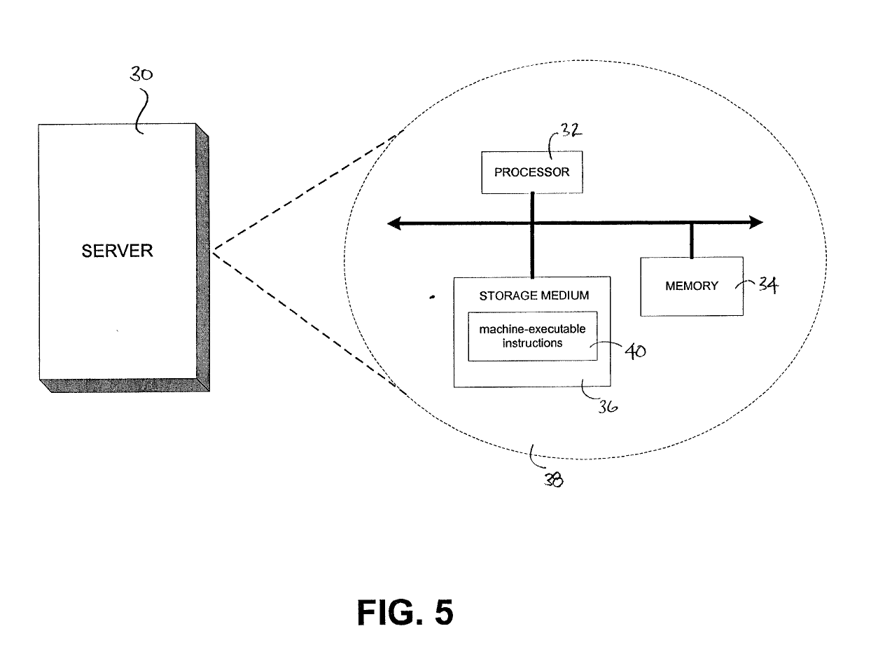

FIG. 5 shows a server (computer) 30 on which process 10 may be executed. Server 30 includes a processor 32, a memory 34, and a storage medium 36 (e.g., a hard disk) (see view 38). Storage medium 36 stores machine-executable instructions 40, which are executed by processor 32 out of memory 34 to perform process 10 on incoming data units, such as ATM cells, to serve them to a network.

Process 10, however, is not limited to use with the hardware and software of FIG. 5; it may find applicability in any computing or processing environment. Process 10 may be implemented in hardware, software, or a combination of the two. Process 10 may be implemented in one or more computer programs executing on programmable computers or other machines that each includes a processor, a storage medium readable by the processor (including volatile and non-volatile memory and/or storage elements).

Each such program may be implemented in a high level procedural or object-oriented programming language to communicate with a computer system. However, the programs can be implemented in assembly or machine language. The language may be a compiled or an interpreted language.

Each computer program may be stored on an article of manufacture, such as a storage medium or device (e.g., CD-ROM (compact disc read-only memory), hard disk, or magnetic diskette), that is readable by a general or special purpose programmable machine for configuring and operating the machine when the storage medium or device is read by the machine to perform process 10. Process 10 may also be implemented as a machine-readable storage medium, configured with a computer program, where, upon execution, instructions in the program cause the machine to operate in accordance with process 10.

The invention is not limited to the specific embodiments described herein. For example, the invention can be used with multiple applications, not just the two L and H applications described above. The invention is not limited to use with ATM cells or to use with ATM networks. Any type of data unit or data packet may be used. The invention is not limited to use with the hardware and software described herein or to use in a B-ISDN context, but rather may be applied to any type of network. The invention is particularly applicable to real-time applications, such as voice and video interactive communications; however, it may be used with any type of computer application.

Other embodiments not specifically described herein are also within the scope of the following claims.

[image]

[image]

[image]

[image]

What is claimed is:

1. A method of serving data units on a network, comprising:
queuing data units from a first application in a first buffer;
queuing data units from a second application in a second buffer;
moving data units from the second buffer to the first buffer following a predetermined delay; and
serving data units from the first buffer.

2. The method of claim 1, wherein the data units from the first application have a higher priority for transmission on the network than the data units from the second application.

3. The method of claim 1, wherein the data units from the first application and the data units from the second application are served from the first buffer on a first-come-first-served basis.

4. The method of claim 1, further comprising:
discarding data units from the first application that exceed a first time delay; and
discarding data units from the second application that exceed a second time delay.

5. The method of claim 4, wherein the second time delay exceeds the predetermined time delay.

6. The method of claim 1, wherein the data units from the second buffer are moved to an end of the first buffer after data units from the first application.

7. The method of claim 1, further comprising:
determining a time to move the data units from the second buffer to the first buffer.

8. The method of claim 7, wherein a circular buffer, a pointer and a timer are used to determine the time to move the data units from the second buffer to the first buffer.

9. The method of claim 1, further comprising:
serving data units from the second buffer when the first buffer is empty.

10. The method of claim 1, wherein the data units comprise Asynchronous Transfer Mode (ATM) cells and the network comprises an ATM network.

11. A computer program stored on a computer-readable medium for serving data units on a network, the computer program comprising instructions to:
queue data units from a first application in a first buffer;
queue data units from a second application in a second buffer;
move data units from the second buffer to the first buffer following a predetermined delay; and
serve data units from the first buffer.

12. The computer program of claim 11, wherein the data units from the first application have a higher priority for transmission on the network than the data units from the second application.

13. The computer program of claim 11, wherein the data units from the first application and the data units from the second application are served from the first buffer on a first-come-first-served basis.

14. The computer program of claim 11, further comprising instructions to:
discard data units from the first application that exceed a first time delay; and
discard data units from the second application that exceed a second time delay.

15. The computer program of claim 14, wherein the second time delay exceeds the predetermined time delay.

16. The computer program of claim 11, wherein the data units from the second buffer are moved to an end of the first buffer after data units from the first application.

17. The computer program of claim 11, further comprising instructions to:
determine a time to move the data units from the second buffer to the first buffer.

18. The computer program of claim 17, wherein a circular buffer, a pointer and a timer are used to determine the time to move the data units from the second buffer to the first buffer.

19. The computer program of claim 11, further comprising instructions to:
serve data units from the second buffer when the first buffer is empty.

20. The computer program of claim 11, wherein the data units comprise Asynchronous Transfer Mode (ATM) cells and the network comprises an ATM network.

21. An apparatus for serving data units on a network, comprising:
a first buffer to queue data units from a first application;
a second buffer to queue data units from a second application; and
a controller to (i) move data units from the second buffer to the first buffer following a predetermined delay, and (ii) serve data units from the first buffer.

22. The apparatus of claim 21, wherein the data units from the first application have a higher priority for transmission on the network than the data units from the second application.

23. The apparatus of claim 21, wherein the data units from the first application and the data units from the second application are served from the first buffer on a first-come-first-served basis.

24. The apparatus of claim 21, wherein the controller discards data units from the first application that exceed a first time delay, and discards data units from the second application that exceed a second time delay.

25. The apparatus of claim 24, wherein the second time delay exceeds the predetermined time delay.

26. The apparatus of claim 21, wherein the data units from the second buffer are moved to an end of the first buffer after data units from the first application.

27. The apparatus of claim 21, wherein the controller determines a time to move the data units from the second buffer to the first buffer.

28. The apparatus of claim 27, wherein the controller uses a circular buffer, a pointer and a timer to determine the time to move the data units from the second buffer to the first buffer.

29. The apparatus of claim 21, wherein the controller serves data units from the second buffer when the first buffer is empty.

30. The apparatus of claim 21, wherein the data units comprise Asynchronous Transfer Mode (ATM) cells and the network comprises an ATM network.
